(19) United States
(12) Patent Application Publication
(10) Pub. No.: US 2003/0062443 A1
(43) Pub. Date: Apr. 3, 2003

(54) VTOL personal aircraft

(76) Inventors: Joseph Wagner, Ozark, AL (US); Anthony Pruszenski JR., Newburyport, MA (US); Karl F. Milde JR., Mahopac, NY (US)

Correspondence Address: Karl F. Milde, Jr., Esq., MILDE & HOFFBERG, L.L.P., Suite 460, 10 Bank Street, White Plains, NY, 10606, US

(21) Appl. No.: 10/114,754

(22) Filed: Apr. 2, 2002

Related U.S. Application Data
(63) Continuation-in-part of application No. 09/968,934, filed on Oct. 2, 2001.
(60) Provisional application No. 60/354,808, filed on Feb. 6, 2002.

(51) Int. Cl. B64C 15/02; B64C 29/00

(52) U.S. Cl. 244/12.3

(57) ABSTRACT

A personal aircraft (PAC) capable of vertical take-off and landing (VTOL) comprises a passenger compartment having a front, a rear and two sides, and a plurality of independently powered thrusters attached to the outer periphery of the compartment. At least two thrusters are disposed on each side of the compartment. The thrusters, which are preferably ducted fan units, are capable of providing a vertically upward force to the compartment. The thrusters preferably comprise a “Levitator” which creates lift from the airfoil-like air inlet as well as from the acceleration of air from inlet to outlet.

### CROSS-REFERENCE TO RELATED APPLICATION

This application is a continuation-in part of application Ser. No. 09/968,934 filed Oct. 2, 2001. This application also claims subject matter disclosed in the provisional patent application Serial No. 60/354,808, filed Feb. 6, 2002.

### BACKGROUND OF THE INVENTION

The present invention relates to a personal aircraft (PAC) which is capable of taking-off and landing vertically, as well as hovering, if desired.

A PAC of this type is disclosed in the U.S. Pat. No. 6,179,247, which patent is incorporated herein by reference. This patent discloses a saucer-shaped personal air transport (PAT) having a plurality of “thrusters” arranged in a circle.

Whereas a craft of this type is capable of maneuvering forward and back, as well as side to side, its forward speed is somewhat limited by the drag induced by its relatively large cross-section. Also, since this craft is wingless, a considerable amount of energy, and thus fuel, is required to keep it aloft.

A more fuel efficient configuration has been developed by Moller International Corp. of Davis, Calif. (WWW.MOLLER.COM). This configuration, called the “Skycar”, is powered by four ducted fan units, two on each side of a passenger compartment or fuselage. The fuselage is aerodynamically shaped to permit high speed (up to 500 MPH) travel with reasonable fuel efficiency.

One major disadvantage of the Skycar is that it requires the thrust of all four ducted fan units to remain aloft. If one of these fan units or “thrusters” fails, the craft will fall from the sky.

Further, the lift provided by the fuselage and other parts of the craft at forward speeds is insufficient to maintain the craft aloft at relatively low forward speeds. Consequently, the Skycar requires a continuous upward force to be applied to the craft by the four ducted fans.

### SUMMARY OF THE INVENTION

It is an object of the present invention to improve the safety of a vertical take-off and landing (VTOL) aircraft of the type described above.

It is a further object of the present invention to improve the fuel efficiency of a VTOL aircraft of the type described above.

These objects, as well as other further objects which will become apparent from the discussion that follows, are achieved, in accordance with the present invention, by providing a personal aircraft (PAC) which comprises:

(a) a passenger compartment having four sides: a front side, a rear side and two lateral sides; and

(b) a plurality of independently powered thrusters attached to the compartment, with at least two and preferably three or more thrusters disposed on two opposite sides of the compartment, to provide a vertically upward force to the compartment.

In this way, if one of the thrusters on each side were to fail, the remaining thrusters would maintain the craft aloft.

According to a particular feature of the invention, the outlet of at least one of the thrusters on each side may be tilted to adjust the direction of force applied to the passenger compartment. In this way, either a forward or reverse force may be applied to the compartment in addition to the upwardly directed force.

According to a further feature of the invention, an additional independently powered thruster is attached to the compartment at the front, the rear, or both the front and rear, to exert a horizontal force to the compartment; e.g., in the forward direction.

According to another preferred feature of the present invention, the aircraft is provided with at least one substantially horizontal wing on each side of the passenger compartment to provide a lifting force during forward movement of the craft. Preferably, there are at least a pair of main wings plus a pair of control wings, such as a canard and/or rear stabilator.

According to still another preferred feature of the present invention, the PAC is provided with a parachute, attached to the top of the passenger compartment, and means for deploying the parachute in case of an emergency.

According to still another preferred feature of the present invention, the PAC is provided with a deployable airbag, attached to the bottom of the passenger compartment, and means for deploying the airbag in case of an emergency.

It is a further object of the present invention to provide a ducted fan unit which is particularly intended for use in a VTOL type of aircraft.

Existing ducted fan configurations provide more or less axial airflow paths and relatively high flow velocities. Their thrust output is in line with the center line of their impellers.

It is thus a specific object of the present invention to provide a ducted fan unit which is configured to provide maximum performance to an aircraft that is capable of vertical liftoff and landing and also a forward flight cruising speed of approximately 50 miles per hour. For this purpose, the output of the ducted fan unit must provide both sufficient vertical thrust to sustain the craft in flight, and a horizontal thrust component sufficient to propel the vehicle at its desired forward cruising speed.

These objects, as well as further objects which will become apparent from the discussion that follows, are achieved, in accordance with the present invention, by providing a ducted fan unit for a PAC, hereinafter sometimes called a “Levitator”, which comprises:

(1) a cylindrical first tube having an inlet, an outlet and a linear, first central axis that is disposed at an angle to the vertical when the aircraft is oriented in its normal upright position such that the inlet is located forward of the outlet, in relation to the direction of travel of the aircraft;

(2) a first impeller disposed in the first tube and arranged to rotate about the aforesaid first central axis to generate airflow from the inlet to the outlet;

(3) a first prime mover coupled to drive the first impeller; and

(4) a second tube having an inlet and an outlet, the outlet of the second tube having substantially the same internal cross-sectional area as that of the first tube, the outlet of the second tube extending into the inlet of the first tube, the inlet of said second tube facing forward in relation to said direction of travel and having a substantially horizontal, second central axis.

The prime mover which drives the first impeller is preferably disposed in the first tube adjacent to this impeller. Advantageously, the prime mover is mounted on a plurality of stator blades which constrain the air to flow through the first tube in the direction of the first central axis.

The prime mover utilized in the ducted fan unit may be any type of engine or motor, such as an internal combustion engine (two cycle, four cycle, gasoline, diesel or the like), a turbo jet engine, or turboprop, or even an electric motor. In the latter case, a separate motor-generator, solar cell, fuel cell or battery, is provided on the aircraft to generate the electricity to power the electric motors of the several thrusters.

If the prime mover is an internal combustion engine, it is advantageous if the intake port, for the aspiration of air into the internal combustion engine, be disposed outside of the first tube; that is, outside the turbulent rush of air within the tube.

According to a further feature of the invention, the ducted fan unit also comprises a third tube having an inlet, which has substantially the same internal cross-sectional area as that of the first tube, attached to the outlet of the first tube. The outlet of the third tube, which may be (but does not have to be) circular in cross section, has a third central axis. The third tube has a flexible or articulated portion arranged between its inlet and outlet to allow for the adjustment of the orientation of the third central axis with respect to that of the first central axis. This allows the “exhaust” of the ducted fan unit to be aimed in a desired direction.

Preferably, the first axis is disposed at an angle to the vertical in range of 0 to 90°, preferably 15 to 35°, with the most desirable angle being substantially 26°. The third central axis can be oriented preferentially in alignment with the first central axis, but it can also be adjusted to direct the outflow of air at a different angle.

Advantageously, the ducted fan unit may also have a second impeller to increase the speed of the air at the outlet of the first tube. Preferably, the second impeller is rotated in a direction opposite to that of the first impeller so as to redirect the air to flow in an axial direction within the first tube. Either the first prime mover may drive both the first and second impeller, or a separate, second prime mover may be coupled to drive the second impeller.

The inlet of the second tube may have a circular opening, but, according to a further feature of the present invention, the second tube has a substantially rectangular opening with upper and lower substantially horizontal edges and two side edges (which may be substantially linear and vertical). The upper edge and/or the lower edge of the opening of the second tube is/are advantageously provided with an aerodynamic contour which produces lift due to the airflow into such inlet.

According to still another feature of the present invention, the face of the inlet of the second tube, which is defined by the edge surrounding the inlet opening, has a substantially planar configuration which forms an acute angle with respect to the second central axis. Advantageously, this acute angle is in the range of 0 to 90°, preferably 35 to 55°, with the preferred angle being substantially 45°. This acute angle facilitates the entry of air, no matter whether the PAC is traveling in the upward and/or the forward direction.

The ducted fan unit according to the invention thus combines several desirable features for the efficient propulsion of a VTOL aircraft (PAC):

1. A non-linear airflow path, configured in such a way as to produce both static and dynamic lift plus forward thrust;

2. An inlet shape and contour configured in such a way as to minimize the incidence of “inlet stall” and air turbulence, and thus minimize unintended variations in thrust output from the “negative feedback” characteristics of decreased air density due to these factors;

3. An outlet configuration that permits controlled deflection of the exit airflow, to provide directional control in flight; and

4. An impeller design and power source designed for relatively high-volume, relatively low-velocity airflow, in order to maximize propulsive efficiency.

The objectives of the invention, stated above, are met by a combination of these design features.

One particularly significant design feature of the ducted fan unit (Levitator) is the angular orientation of the fan impeller axis. For example, with the impeller axis tilted 26° in a forward inclination, the vertical thrust component will equal approximately 90% of the gross thrust developed by the fan unit, while the horizontal component will equal approximately 44% of the gross thrust.

Another important feature of this design augments the vertical lift developed by the fan unit by means of the “Coanda Effect”. The incoming airflow is redirected through a curved inlet passageway, whose surface curvature also functions in somewhat the same manner as lifting airfoil. In a preferred configuration, the leading surfaces of the intake opening are oriented substantially in a horizontal direction. This minimizes the aerodynamic profile drag effect of the duct's cross section and also orients the inflow to provide a maximum reactive lifting effect on the duct surface, augmenting the lifting thrust produced directly by the impeller.

A further advantage of this general configuration is that it makes possible multiple inlets, enabling it to supply air to multiple ducted fan units (Levitators) in a single vehicle. The multiple inlets can be “siamesed”, either vertically or horizontally, to provide minimum interference to the incoming air and maximum intake airflow to all the ducted fan units.

In connection with the duct configuration described above, the duct passage needs to be circular in cross-section only at the impeller. As noted above, the preferred cross-sectional shape for the duct inlet passage is substantially rectangular (although non-rectangular—e.g. circular or oval—inlets can be used). This rectangular shape transitions gradually to a circular one at the impeller.

Because the primary intended use of this ducted fan design is in a VTOL aircraft (PAC), the orientation of the actual intake opening (as distinct from the inlet passage behind it) should preferably be at an angle of between 35° and 55° to the vertical. This is to provide minimal interference to the incoming airflow when the aircraft is in either a vertical or a horizontal mode of flight.

The outflow or third section of the duct is preferably circular in cross-section, and contains a flexible “bellows” segment, or an articulated section, which enables the outflow to be diverted in any desired direction, as a means of flight path control.

Existing ducted fans in general are relatively low in propulsive efficiency. To improve performance in the ducted fan unit according to the invention, the following features are contemplated:

(1) The intake air for the prime mover in the unit is preferably taken from a “static source” or plenum outside the duct, so as to maximize the density of the combustion air; and

(2) The impeller blades are preferably made with glass-smooth rear surfaces, but with matte front surfaces on the forward 30% of the blade chord.

In the application for which ducted fan unit is intended, there are no inherent restrictions on impeller diameter since the PAC is not intended for high speed flight. Therefore, to maximize efficiency (and thus to reduce the fuel load required to provide a reasonable cruising range) the duct diameter is preferably made as large as practicable. This improves flow efficiency by maximizing the mass of the airflow and minimizing excess “slipstream” velocity.

Since the design performance of the PAC is known (or can be estimated), standard propeller selection criteria can be usefully employed in the design of the impeller for this ducted fan unit. In fact, the unit may be designed to be closer to a “shrouded propeller” than to the usual ducted fan, resulting in a further gain in efficiency.

In summary, the present invention provides a personal aircraft (PAC) which combines a number of salient features that increase safety, stability and efficiency. These features include:

(1) Multiple ducted fan units, each with a separate prime mover, to provide lift.

(2) Ducted fan units of a particular advantageous design which matches the VTOL and low cruising speed requirements of a PAC.

(3) Contoured inlets to the ducted fan units to maximize static thrust and minimize the interference between adjacent ducts and forward motion.

(4) Control of the thrust produced by the individual ducted fan units by controlling one or more of the following:

output power of the prime mover(s) in each unit;

impeller blade pitch;

inlet or outlet vectoring; and

inlet or outlet area variation.

(5) Providing auxiliary lifting control surfaces in the form of canards, rear elevators or stabilators.

(6) A control system which provides vehicle stability during normal operation as well as during partial or full engine failure in one or more of the ducted fan units.

(7) A recovery system in the form of a parachute or deployable lifting-drag surfaces in the event of catastrophic engine failure.

(8) An inflatable airbag to absorb low-level drop height energy due to engine failure.

(9) A suitable operator interface to allow safe operation and navigation.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of a first preferred embodiment of a personal aircraft (PAC) according to the present invention.

FIG. 2 is a top view of the PAC of FIG. 1.

FIG. 3 is a side view of the PAC of FIG. 1.

FIG. 4 is a front view of the PAC of FIG. 1.

FIG. 5 is a perspective view of a second preferred embodiment of a PAC according to the present invention.

FIG. 6 is a top view of the PAC of FIG. 5.

FIG. 7 is a front view of the PAC of FIG. 5.

FIG. 8 is a cross-sectional view of the PAC of FIG. 5.

FIG. 9 is a perspective view of one preferred embodiment of a ducted fan unit according to the present invention.

FIG. 10 is a cross sectional view of the ducted fan unit of FIG. 9.

FIG. 11 is a detailed, cross sectional view of two ducted fan units of the type shown in FIG. 9.

FIG. 12 is a perspective view of a third preferred embodiment of a PAC according to the present invention, which incorporates eight ducted fan units of the type shown in FIGS. 9-11.

FIG.13 is a top view of the PAC of FIG. 12.

FIG. 14 is a perspective view of a fourth preferred embodiment of a PAC according to the present invention, which incorporates eight ducted fan units of the type shown in FIGS. 911.

FIG. 15 is a top view of the PAC of FIG. 15.

FIG. 16 is a device for adjusting the orientation in one dimension of the outlet tubes of two siamesed ducted fan units of the type shown in FIGS. 9-11.

FIG. 17 is a representational diagram of a device for adjusting the orientation in two dimensions of the outlet tubes of four siamesed ducted fan units of the type shown in FIGS. 9-11.

### DETAILED DESCRIPTION OF THE PREFERRED EMBODIMENTS

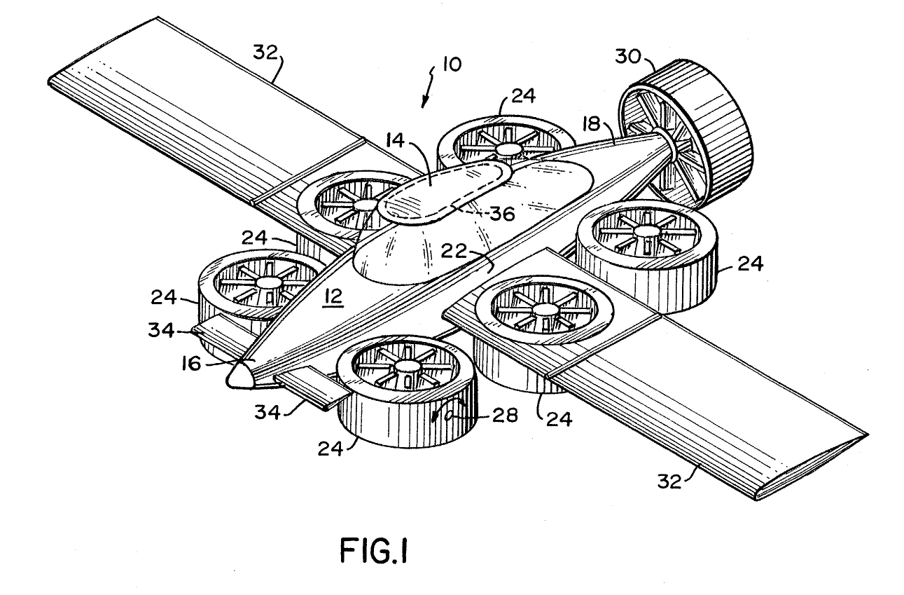

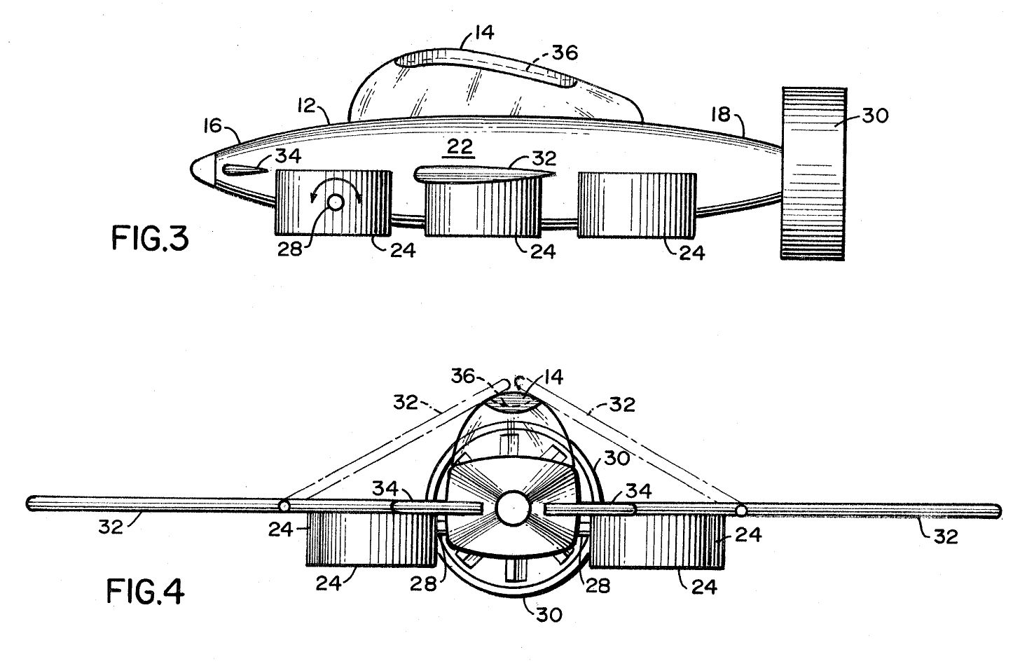

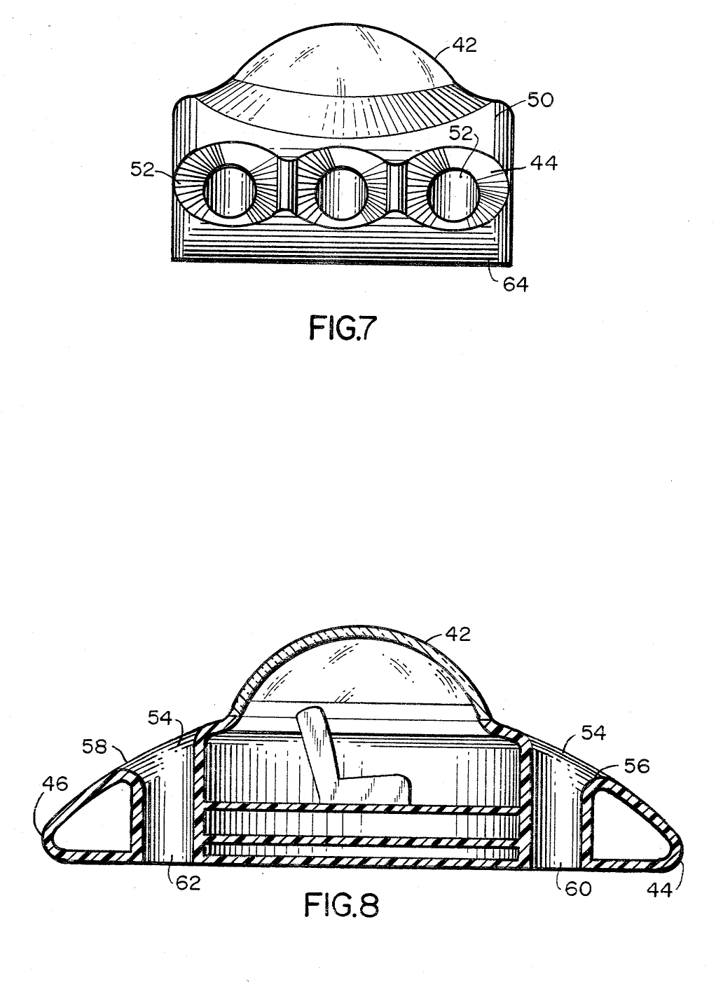

The preferred embodiments of the present invention will now be described with reference to FIGS. 1-17 of the drawings. Identical elements in the various figures are identified with the same reference numerals.

In the first embodiment of the invention, shown in FIGS. 1-4, the personal aircraft (PAC) 10 comprises a passenger compartment or fuselage 12 having a top 14, a front 16, a rear 18 and two sides 20 and 22, respectively. Attached to each side of the compartment are at least two, and in this case three, “thrusters” 24, preferably ducted fan units. These fan units may, for example, be the type employed by Moeller International Corp. in the aforementioned Skycar. Other ducted fan units are disclosed in the aforementioned U.S. Pat. No. 6,179,247.

Because of the redundancy of thrusters, the loss of power in one thruster on each side would not result in a catastrophic failure of lift. By increasing the thrust of the remaining thrusters on the side where the failure occurred, the craft will remain under control and can be lowered safely to the ground.

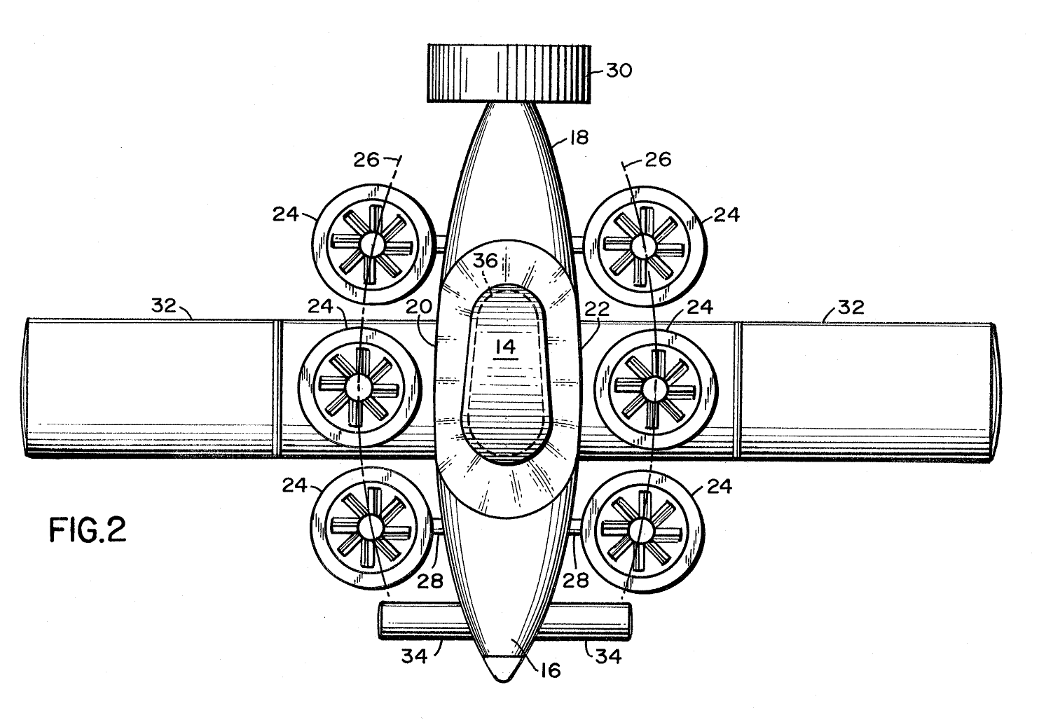

As shown in FIG. 2, the central, rotational axes of the thrusters 24 are arranged along a curved line 26 which follows the outward curve of the fuselage. Alternatively, the axes of the thrusters may be arranged along a straight line, so that the thrusters lie one behind the other in the direction of travel thus minimizing drag.

Preferably, the amount of thrust generated by each of the thrusters is independently controllable by the pilot, or by a computer, in the passenger compartment. This allows the pilot, or computer, to adjust the thrust of the remaining thrusters in case of a failure of one or more thrusters.

According to a preferred feature of the invention, the forward thrusters 24 (or rearward thrusters, or all the thrusters) are arranged on a pivot 28 and can be tilted or rotated about the pivot to adjust the direction of force which these thrusters apply to the passenger compartment. Rotating the forward thrusters counterclockwise from the vertical position increases the forward force applied to the compartment; rotating them counterclockwise from the vertical position increases the reverse force applied to the compartment.

Preferably also, the PAC is provided with an additional fan 30, either ducted or non-ducted, arranged at either the front, the rear or both the front and rear of the passenger compartment, to exert a force in the horizontal direction. In flight, this thruster 30 provides the principal lateral motivating force to the craft.

When the PAC is moving in the forward direction, it is possible to take advantage of its motion through the air to add lift to the vertical forces generated by the thrusters 24. This lift is affected by a pair of conventional wings 32 extending from each side of the passenger compartment 12. As may be seen in FIGS. 1 and 2, the wings 32 preferably surround the center thrusters 24 and are open at the top to allow air to enter these thrusters.

In order to save space when the PAC is stored or garaged on the ground, the wings 32 may be folded upward toward the passenger compartment, as is best illustrated in FIG. 4.

In addition, for control purposes, a stabilizing wing or canard 34 may be provided at the front of the fuselage. Alternatively or in addition, a rear stabilizer, and also a rudder, may be provided at the rear of the passenger compartment.

To provide an extra measure of safety, the PAC also preferably includes a parachute unit 36 disposed at the top 14 of the passenger compartment. This parachute unit 36 is arranged in line with the center of gravity of the craft. At the press of a button within the passenger compartment, means, such as a solid fuel rocket, are ignited to lift the parachute out of its compartment for deployment in the air.

In the second embodiment of the invention, shown in FIGS. 5-8, the personal aircraft (PAC) 40 comprises a passenger compartment or fuselage 42 in the shape of a “lifting body” having a front side 44, rear side 46 and two lateral sides 48 and 50. Built into the front side 44 are three thrusters 52 in the form of ducted fan units. Also, built into the rear side 46 are three thrusters 54, also in the form of ducted fan units. These thrusters are independently powered, for reasons of redundancy, and are capable of providing vertical lift. These thrusters also provide lateral thrust to the aircraft when the craft is tilted, either forward or backward, or when the thrust is deflected laterally by one or more deflectors (not shown).

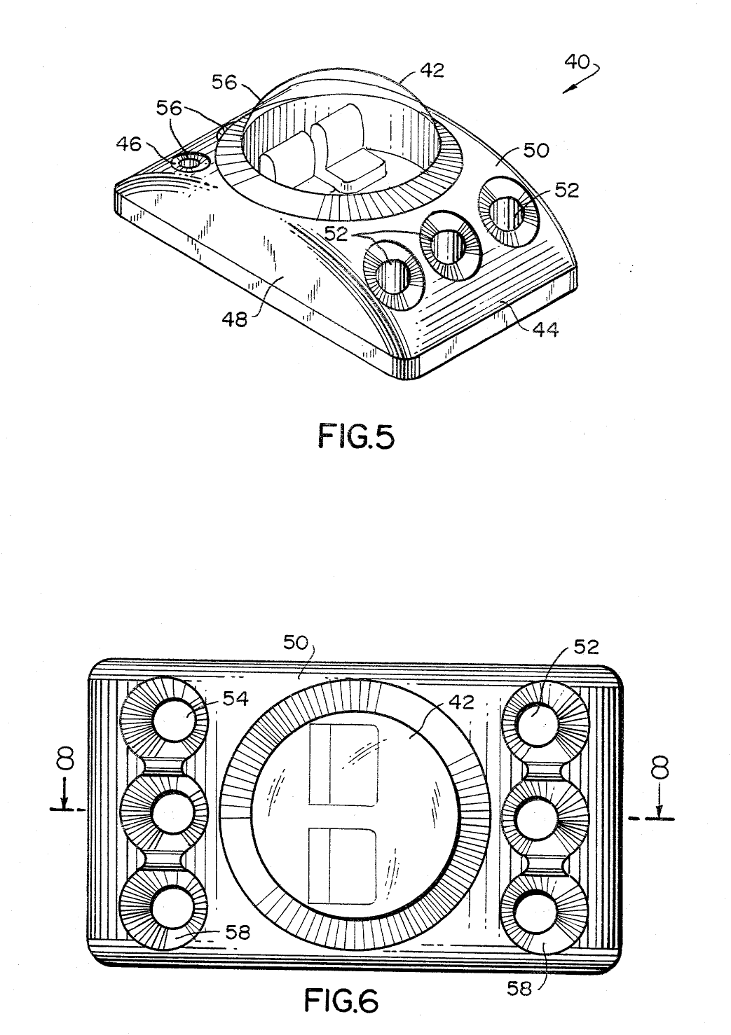

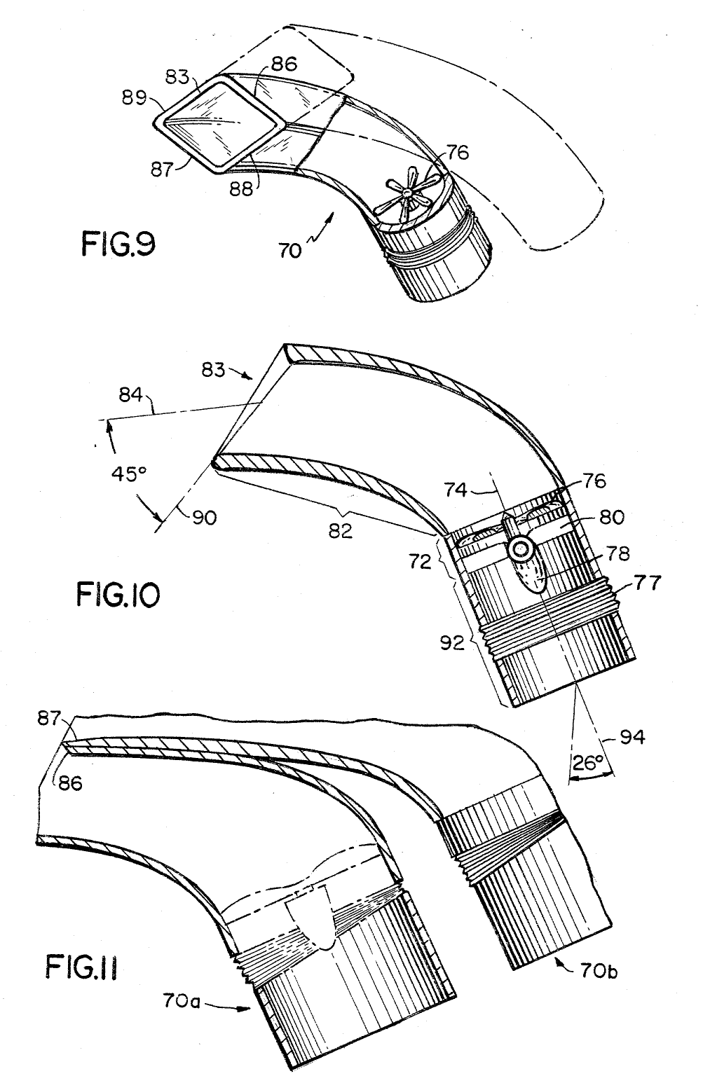

As shown in FIG. 6 in top view and in FIG. 8 in cross sectional view, the ducted fan units 52 and 54 comprise a tapered opening 56 and 58, respectively, and a circular tube 60 and 62, respectively, in which the air is accelerated by one or more impellers driven by one or more prime movers (not shown).

Advantageously, the outlets of one or more of these ducted fans may be provided with air deflectors (not shown) in a manner known in the art to deflect the exhaust stream of air in any desired direction. Such deflectors may be used for attitude control as well as to cause the aircraft to be propelled horizontally in any desired direction.

Alternatively, or in addition, the amount of thrust delivered by each thruster is independently controlled so that the altitude, attitude and horizontal motion of the aircraft is controllable entirely, or at least partially, by controlling the thrust of the individual thrusters.

According to a particular feature of the invention, a deployable airbag 64 is installed on the bottom of the passenger compartment to cushion the fall in case of a loss of power and thrust (lift) at low altitudes. The airbag may be deployed, for example, upon sensing a loss of thrust in one or more of the thrusters 52 and 54.

As will be understood from the configuration of the thrusters in the two PAC embodiments of FIGS. 1-4 and FIGS. 5-8, the loss of thrust in one of the thrusters on one side of the aircraft (either a front side, a rear side or on lateral side) will not result in a catastrophic fall of the craft. Rather, the output of the remaining thrusters on that side can be increased to compensate for the loss of power in one of the thrusters, at least until the craft can be brought down to a safe landing.

In the first two embodiments of the PAC shown in FIGS. 1-4 and FIGS. 5-8, any conventional ducted fan unit may be used as a thruster. FIGS. 9-11 illustrate the preferred embodiment of a particular ducted fan unit according to the present invention.

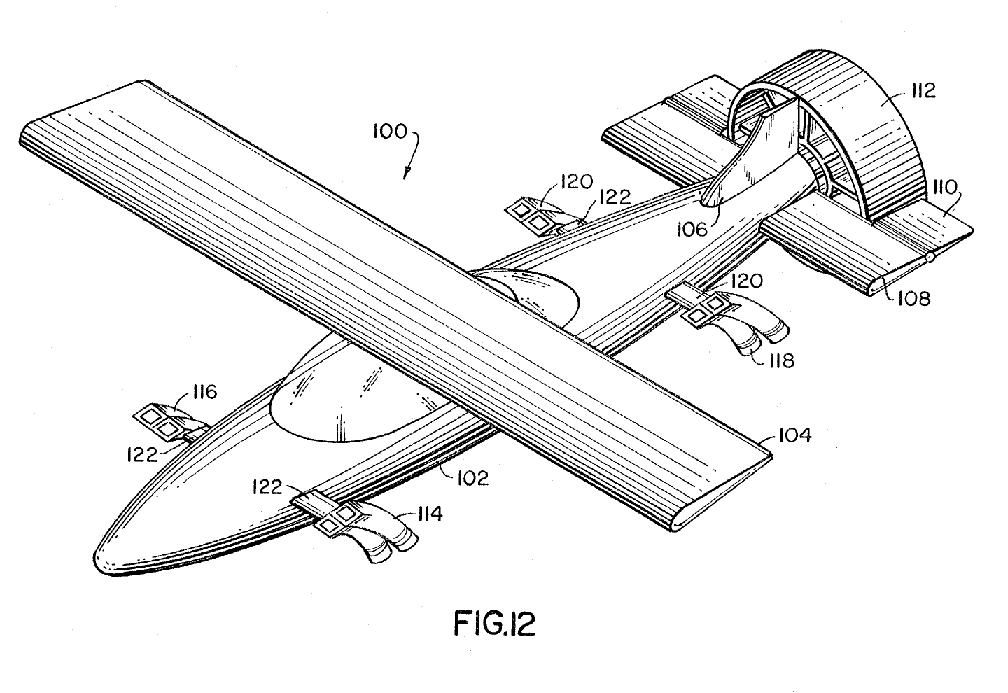

As shown in perspective view in FIG. 9, and in cross-sectional view of FIG. 10, the ducted fan unit 70 comprises a first cylindrical tube portion 72 having a first central axis 74 disposed at an angle to the vertical. The first tube surrounds an impeller 76 which is driven by an internal combustion engine 78 mounted on stater blades 80 that “straighten” the flow of air forced downward by the impeller blades 76.

A second tube portion 82, having a substantially rectangular inlet and a circular outlet, is mounted ahead of the tube 72 relative to the direction of flow of the air. The outlet of the second tube 82 is cylindrical and has the same internal diameter as that of the first tube, the outlet of the second tube extending coaxially with and smoothly into the inlet of the first tube. The inlet 83 of the second tube, on the other hand, faces forward in the direction of travel and has a substantially horizontal, second central axis 84.

The inlet 83 of the second tube 82 is substantially rectangular in shape having upper and lower substantially horizontal edges 86 and 87, respectively, and two side edges 88 and 89. The upper edge of the opening in the inlet of the second tube and/or the lower edge of this opening has an aerodynamic contour which produces lift due to airflow into the inlet 83.

The edges 86-89 of the inlet 83 define a substantially planar face 90 of the inlet which forms an acute angle with respect to the second central axis 84. This acute angle is between 0 and 90°, preferably in the range of 35 to 55°, and more preferably in the center of this range; i.e., at 45°.

The ducted fan unit 70 also has a third tube portion 92 with an inlet and an outlet 93. The inlet of this third tube is cylindrical and has the same internal diameter as that of the first tube 72, the outlet of the first tube extending coaxially with, and smoothly into, the inlet of the third tube. The outlet 93 of the third tube is also preferably circular in cross-section and has a third central axis 94. A flexible portion, such as a bellows 86, or an articulated portion, is arranged between the inlet and the outlet of the tube 92 to allow for the adjustment of orientation of its third central axis 94 and, thus, its outlet 93.

As will be explained herein below, a hydraulic, pneumatic or other mechanical device is provided to adjust the orientation of the outlet 93 of the third tube.

Advantageously, the first tube 72 is made somewhat longer and a second impeller is disposed therein to rotate about the first central axis 74 in a direction opposite to the direction of rotation of the first impeller. This second impeller not only serves to increase the outflow speed of air at the outlet of the first tube but it also compensates the radial component of the airflow imparted by the first impeller 76. The second impeller may be driven by the engine 78 or by a second engine mounted either inside or outside the tube 72.

Similar engines for this application are well known and used in large model airplanes, small motorcycles and the like. Engines of this type are disclosed in the above-referenced U.S. Pat. No. 6,179,247.

Advantageously, where internal combustion engines 78 are used to drive the impeller(s), the air intake ports of such engine(s) are disposed outside of the first tube. This arrangement increases the density of air aspirated by the engine(s).

As shown in FIG. 10, the first central axis 74 of the first tube 72 and (when the third axis is in alignment therewith) the third axis 94 of the tube 92 are disposed at angle to the vertical. This angle is preferably in the range of 0 to 90°, preferably 15 to 35° and, specifically preferably approximately 26°.

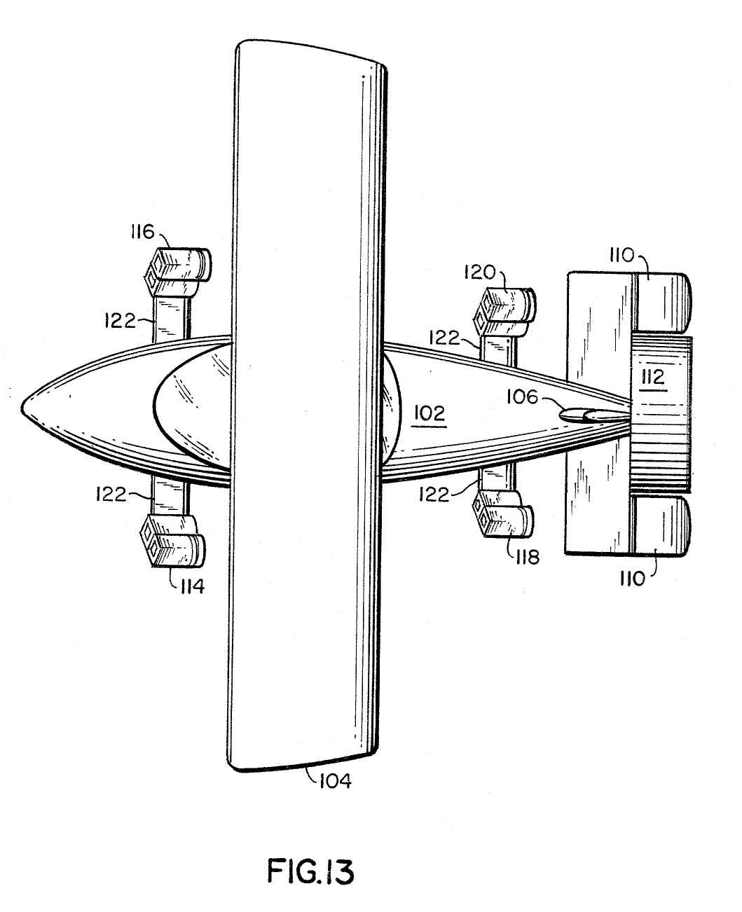

As is shown in phantom view in FIG. 9 and in cross-sectional view in FIG. 11, the ducted fan unit 70 may be “siamesed” with a second, similar or identical unit.

As mentioned above, the horizontal edges 86 and 87 of the inlet 83 are contoured to provide “lift” due to the flow of air. Although the precise curvature may be experimentally determined, suffice it to say that the inlet edge surfaces may be shaped in the manner of an aircraft wing airfoil to take advantage of Bernoulli's Principle and the Coanda Effect.

FIG. 11 illustrates how the upper edge 86 of one ducted fan unit 70a may be paired with the lower edge 87 of a second, siamesed ducted fan unit 70b.

If the side edges 88 and 89 of the ducted fan unit are substantially linear and vertical, the units may be paired side-by-side as well as one above the other.

Set forth below is a detailed discussion of various aspects of the ducted fan unit (Levitator) of FIGS. 9-11, some of which have been described initially above:

Rectangular Inlet: The ducted fan unit is designed specifically to meet the operational requirements of the PAC. These include (but are not limited to): forward cruising flight at approximately 50 mph with a top speed of 100 MPH; the ability to take off and land vertically; precision controllability at zero or low flight speeds; and efficient, lightweight propulsion in all flight regimes.

It is assumed that most PAC flight time will occur in point-to-point travel; i.e. generally forward flight. But it is also assumed that the PAC will utilize the capability of hovering for periods of fifteen minutes or more.

For maximum safety the PAC incorporates multiple and redundant ducted fans units. It is vital that all of these D-F units operate, in every flight regime, with minimal interference. More specifically, no fan unit should block or reduce the intake airflow volume or density of any other unit when hovering. When a forward speed is attained which provides sufficient lift to support the craft, some interference may be permitted although such interference should be minimized.

The provision of the rectangular inlet is based on this major consideration. Since multiple ducted fan units are used in the PAC, rectangular-shaped intakes permit efficient “stacking” of these units, both mechanically and aerodynamically. FIG. 6 depicts a vertically-joined pair of D-F units. Another vertically joined pair can be arranged horizontally alongside, if desired.

In addition, there is an aerodynamic advantage to a rectangular air inlet over a circular one. In particular, as is discussed below, the inlet may be shaped to provide extra lift to the craft.

Slanted Inlet Face: The inlet face is set at an angle to the perpendicular to the inlet air path centerline to improve airflow during hovering. If the inlet faces of all the D-F units were vertical, in hovering flight the uppermost intakes could “steal” air from the lower ones. Slanting the inlet face permits vertical joining or “siamesing” two D-F units with minimal flow interference to incoming air to the two inlet openings.

A 45 degree angle with respect to the vertical appears geometrically optimal for the inlet face slant, because it presents the same “normal face area” in both vertical plan view and horizontal front view.

However, since the actual angle of the entering airstream will be strongly influenced by its entering velocity, a smaller inlet face angle (closer to vertical) may prove to be more efficient in a “siamesed” D-F unit configuration. The optimum angle can be easily determined by experiment.

The Inlet Passage: The inlet passageway of the D-F unit should be designed to provide maximum flow volume, as required by the PAC application. Ideally, the maximum airstream velocity increase should occur only at the impeller because the D-F unit is a reactive device. For maximum thrust, it needs to accelerate as much air mass as possible—and this requires maximal air density at the impeller face.

For highest efficiency, the D-F units must minimize all obstructions to the through airflow. Anything that reduces the flow volume reduces thrust. A poorly designed inlet may even produce a negative feedback effect at the impeller, causing it to over-speed as its flow output drops.

The Outlet Passage: The outlet of the D-F unit should be designed to maximize the static thrust. Experiments have shown that flaring the outlet can slightly increase the static thrust; however, such flaring is not necessary and it may impair the ability to control the craft by deflecting the outlet flow.

Nominal angle of the Outlet Passage: Aeronautical engineers have several convenient “rules of thumb” that they find useful in the initial design stages of an aircraft. One of these involves the “lift-to-drag” (L/D) ratio of the aircraft. This is the relationship between how much lift can be generated by a wing, a rotor, a lifting body (or whatever) and how much power is required to move the aircraft in flight at the desired speed.

For example, a Cessna 172 aircraft in “clean trim” has an L/D ratio of about 7.9. Among other things, this means that with a gross weight of 2400 pounds, slightly more than 300 pounds of thrust are needed for level flight.

As a first approximation a flying PAC may be designed to have an L/D of 2 in “cruising flight”. In other words, while the craft would need enough vertical lifting capability (vertical thrust) from its D-F units to support its gross weight (say, 1500 pounds with a full complement of fuel) when hovering, it would require a forward thrust equal to only about half this vertical lifting capability to sustain forward flight.

The outlet passage of the D-F unit is set at 26 degrees to meet the “L/D=2” criterion for both hovering and forward flight. Using the well-known “triangulation of forces” principle and trigonometric tables (or a scientific calculator) it may be shown that a 26 degree inclination produces almost exactly a 2:1 ratio between vertical and horizontal components.

To eliminate forward thrust while hovering, the inclination of the outlet passage is made adjustable, so as to direct the air vertically downward during the hovering mode.

Shape of Inlet Passage: The “single surface airfoil” shape of the inlet passage is an aerodynamic shape which results in optimal airflow over and across the leading edge of an aircraft wing and provides an extremely high lift to drag ratio.

The airfoil shape of the leading edge is not a true circle with a radius. It has a circular radius at its very front (less than 2% of the total chord)—but, aft of that, the adjacent curvature is substantially parabolic.

This cross-sectional configuration (airfoil) of the interior surfaces of at least the top and bottom sides (if not also the vertical sides) of the rectangular intake opening is an important feature of the present invention. The flow of air passing near the intake edges will not be axial. The direction of airflow is caused to change, with as little turbulence generation as possible, so as to minimize the inlet stalling tendencies while increasing the air density within the inlet.

The top and bottom surfaces of inlet passage of the D-F unit are also configured to generate additional lift for the PAC. Such a lifting passage was used on an aircraft called the Custer Channel Wing developed in the immediate post-WW2 years. It featured two semi-circular “wings” and two engine-driven propellers pointing forward within the wings, having the same radius as the wing's curvature. The wings and propellers thus formed two semi-ducted fans.

The Channel Wing flew extremely well. At least two flying prototypes were built. Lift was developed at low forward speed by the aerodynamic effects of the propeller slipstream passing over the semi-cylindrical wings.

This craft had a fatal weakness, however: it could not fly with one engine out. Nor did it have any gliding capability: the Channel Wing needed engine power to stay aloft.

The “top” and “bottom” interior contours of the D-F inlet duct are designed to produce appreciable dynamic lift from the air passing over them—in the same way as the Custer Channel Wing. But in this application, efficiency is substantially greater because:

(1) The air flows over two lift-generating surfaces rather than one; and

(2) The airflow passing over the top and bottom inlet duct contour is linear, rather than the spiraling slipstream behind the Channel Wing's propellers.

D-F Unit Construction: The drawings which illustrate the configuration and features of the ducted fan unit are not to scale. In actuality the proportions of the most efficient fan unit configuration may be much “flatter” in overall height. The “tailpipe” length aft of the flexing section is preferably at least equal to its diameter, in order to provide efficient directional flow control when the outlet section is deflected. The optimum useful length can easily be established by experiment.

The ductwork for the ducted fan can be constructed of lightweight, easy-to-fabricate materials: fiberglass composites, thermo-plastics, aluminum, even laminated wood. Advantageously, a sandwich construction may also be used with a foam or honeycomb core.

D-F Unit Operation: An “energy-efficient” D-F unit needs to maximize mass flow, and minimize the difference between vehicle speed and slipstream velocity.

One way to view a ducted fan is as a means for creating a pressure differential, especially since pressure is quite convenient to measure. However, this is actually irrelevant to the way a ducted fan provides thrust. Thrust is generated by propelling a mass of air in one direction; and the physical reaction to that movement of air results in thrust in the opposite direction.

An increase in either the mass or the velocity of the air, or both, increases the reaction effect (static thrust) of the D-F unit, though not to the same degree. If the mass is doubled, the power requirement doubles and the reaction doubles. However, doubling the air velocity requires approximately 2.8 times the power.

The simplest was to increase air mass driven by the impeller of a D-F unit is to increase the diameter of the duct. Similarly, the simplest way to increase the velocity of airflow in a D-F unit is to increase in the power applied to the impeller. However, as the power applied to the impeller is increased, the efficiency of the D-F unit is decreased.

Power to Weight Ratio: The fundamental goal in the design of a PAC is to minimize the gross weight: that is, the weight which includes the fuel as well as the tanks needed to hold that fuel. Every extra pound of mass in the PAC requires extra lifting power to sustain it in flight—and such extra power requires an extra expenditure of energy (fuel).

This is a good example of a vicious circle. An increase in power requires a stronger engine and higher fuel consumption. To achieve this, the aircraft structure must be made stronger to support the extra engine weight and torque and the extra weight of the fuel. This increases the weight of the craft and requires increased power.

Consequently, the airframe and ducted fan units of the PAC must be made simple and as lightweight as possible. For the D-F units, engines must be selected which are highly energy (fuel) efficient and which have a high horsepower to weight ratio—in the order of 2 horsepower per pound or greater. With such engines, which are commercially available for example from the sources indicated above, only about one third of the gross weight of the craft would be required for both the engines and fuel. Thus for a craft having a gross take-off weight of 1500 pounds, it is projected that the engines and fuel would weigh no more than 500 pounds, leaving five hundred pounds for the craft structure and 500 pounds as a payload.

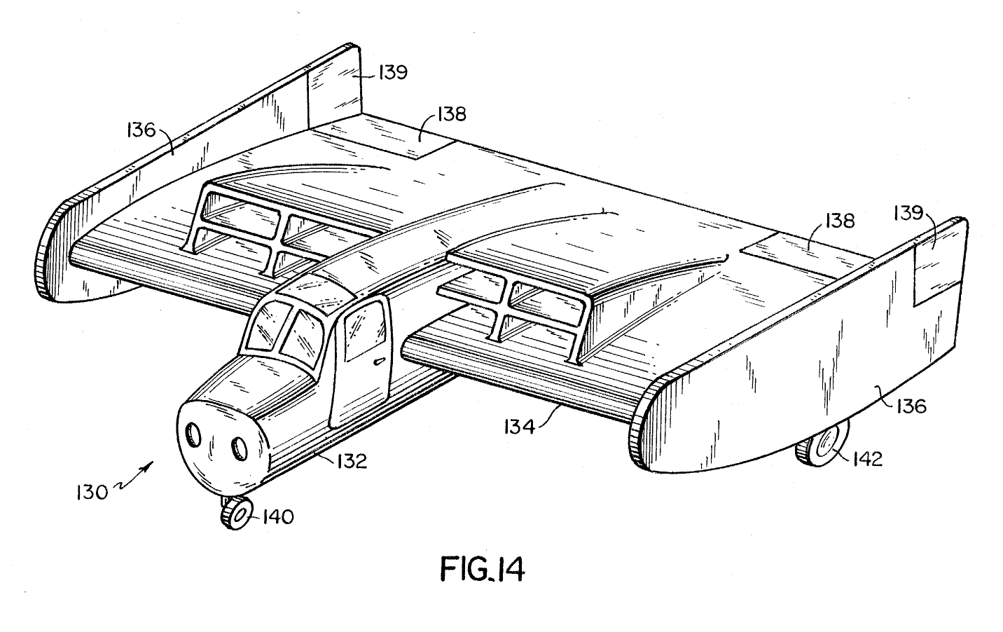

In the third embodiment of the invention shown in FIGS. 12 and 13, the personal aircraft (PAC) 100 comprises a passenger compartment or fuselage 102 which supports a rather conventional wing 104. A tail section of the craft includes a rudder 106 and a horizontal stabilizer 108 with control surfaces 110. The tail also incorporates a ducted fan unit 112, similar to that in the first embodiment of FIGS. 1-4, to provide forward thrust to the aircraft.

Vertical thrust as well as some horizontal thrust is also provided by four sets of ducted fan units 114 and 116, both forward of the wing 104, and 118 and 120, both aft of the wing 104. These sets of ducted fan units are attached to the fuselage, preferably in spaced apart relation by suitable fairings 122.

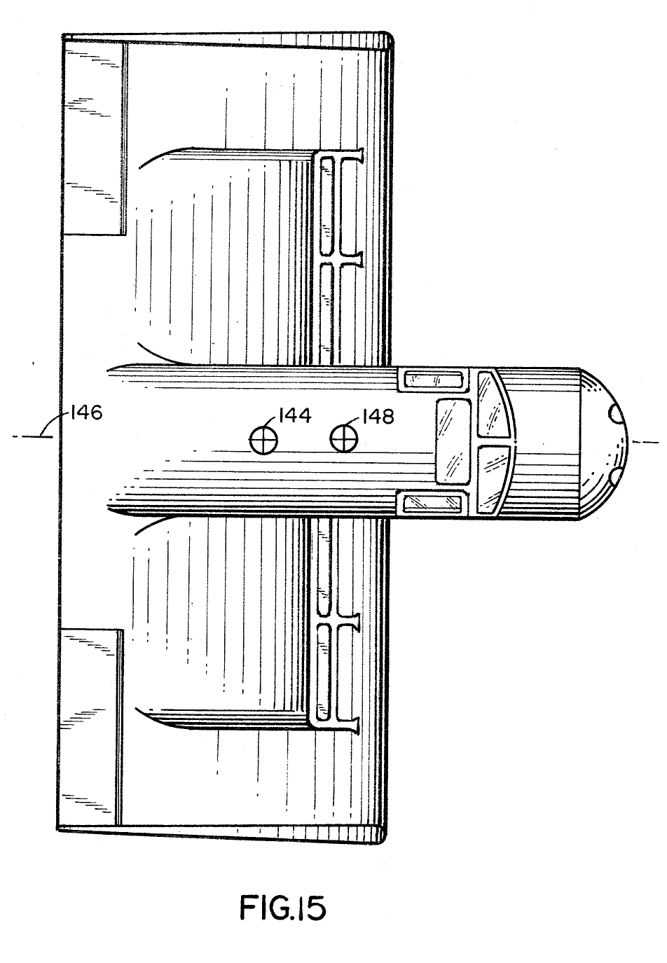

FIGS. 14 and 15 illustrate a fourth embodiment 130 of the personal aircraft (PAC) according to the invention. This embodiment is in the form of a “flying wing”, although the fuselage may be provided with a canard, as desired, to increase stability.

As is shown in FIGS. 14 and 15, the PAC 130 comprises a fuselage 132 and a wing 134 with vertical stabilizer surfaces 136 at each end (“tip bins”). Control surfaces 138 and 139 are provided on the trailing edges of the wing 134 and the vertical stabilizers 136, respectively.

As an example, the fuselage, which extends forward from the wing, may have a total length of 15 feet, from its nose to the trailing edge of the wing, and the wing may have span of 21 feet. The total weight of the craft (without fuel or payloads) may be approximately 1200 pounds.

A nose wheel 140 and a wheel 142 at the end of each wing are provided, not for takeoff and landing (since this craft is designed for VTOL operation) but for convenience in moving the craft about on the ground.

Built into the wing 134 on either side of the fuselage 132 are eight ducted fan units of the type described above in connection with FIGS. 9-11. These ducted fan units function to lift the craft vertically and to provide forward thrust, as desired. The nominal center of lift 144 of the craft is located along the center line 146 somewhat aft of the nominal center of gravity location 148.

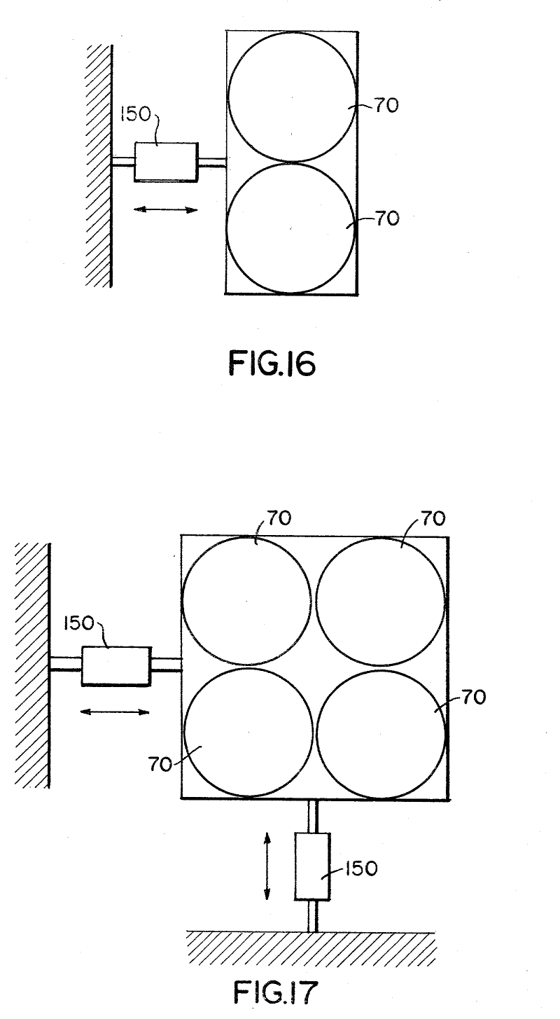

Stability and control of the aircraft are provided by varying the engine speeds of the ducted fan units and by adjusting the orientation of the axis 94 of the outlets of the fan units. Additional aerodynamic control surfaces may be added, as desired. FIG. 16 illustrates a device for adjusting this orientation in one dimension. FIG. 17 shows a device for adjusting this orientation in two dimensions. In FIG. 16, the outlets of two siamesed ducted fan units are moved together; in FIG. 17, the outlets of four siamesed ducted fan units are moved together.

In FIGS. 16 and 17, the devices 150 for moving the outlets of the ducted fan units may be pneumatic, hydraulic or electrically operated. For example, suitable servos may be used to move the outlets of the ducted fan units into any desired configuration.

The configuration of the PAC shown in FIGS. 14 and 15 is an approximation. The aft contours of the passenger “pod” and ducted fan units are smoothly faired, with a minimum of reentrant curvature.

Advantageously, fairings are provided ahead of the ducted fan exits on the underside of the craft. Fuel tanks are preferably located within the ducted fan unit fairings, as close to the center of gravity 148 as practicable.

The airfoil used in this PAC embodiment is preferably a “reflexed” type, chosen for its longitudinal stability in forward flight, particularly at cruising speed.

Directional stability may be enhanced by a small amount of angular “toe-in” on the tip fins 136. Additional vertical fin area may be desirable because of the fins' longitudinal closeness to the craft's center of gravity.

The upwardly directed force (lift) on the aircraft comes from three services:

(1) The ducted fan units generate lift by the positive displacement of air through their rotating impellers.

(2) The top and bottom inner surfaces of the ducted fan units' inlet ducts are shaped so as to act as airfoils, providing lift from the dynamic reaction of the air drawn over them as it passes into the impellers.

(3) During forward flight, the wing area outboard of the ducted fan units act as a conventional aircraft wing.

The four lower (forward) ducted fan units in the PAC include, as the front portion of their lower inlet passage surfaces, the same airfoil as the wing. The four inner ducted fan units include as their inboard inlet passage surfaces, the same surface contour as the passenger pod.

The objective of the aircraft design according to the invention is to provide an optimized configuration for a two-seater Personal Aircraft (PAC), capable of Vertical Takeoff and Landing (VTOL), hovering, and forward flight at cruising speeds of approximately 50 mph. This aircraft is intended to be stable in all flight modes, easily controllable, durable, and as safe as possible for its passengers. Learning to operate it should be at least as easy as learning to drive a sports car, and maintaining it should be no more difficult than the routine maintenance for an inboard-powered motorboat.

The basis of this unique PAC design involves two distinct innovations: the power units, and the airframe configuration.

The name used herein for the PAC power units or “thrusters” is “Levitator”. This name was selected because the fundamental design—consisting of a combination of “ducted fan” features and those of channel-wing and/or box-wing aircraft—is primarily intended as a lift producer.

Levitator Lift-Production Considerations: Ducted Fan units are designed as thrust producers. Their thrust output can be aligned in any desired direction, but it is generally limited to the direct reaction force produced from the axial air mass acceleration that takes place within the duct.

In this respect a ducted fan closely resembles a propeller. It produces thrust in the direction of its centerline.

The Levitator works somewhat differently. Its impeller does produce a thrust output in the direction of its rotational centerline, like a propeller or ducted fan, but in addition, its inlet passageways are so shaped that the incoming air passing over their horizontal surfaces generates “induced lift”.

In this respect, the Levitator operates in the manner of an airplane, in that the propeller's action in moving the aircraft forward induces airflow over substantially horizontal aerodynamic surfaces, and lift is thereby generated.

The Levitator design makes use of the aerodynamic advantages of “channel wing” and/or “box wing” aircraft. That is, like channel wings and box wings, the Levitator produces lift via forced airflow over airfoil-shaped, substantially horizontal surfaces equipped with “end plates” to minimize adverse “tip conditions” such as stalling and lift reduction, particularly at high angles of attack.

The Levitator avoids most aerodynamic disadvantages of channel wings and box wings because of its confined airflow paths. Inlet airflow through the Levitator is essentially linear and non-turbulent; and because all of this flow is dynamically induced by the internal impeller (rather than being at least partly a collateral effect from forward motion of the vehicle) its lifting power is substantially independent of the vehicle's velocity.

In addition, the Levitator design largely overcomes a significant limitation of lift generation via conventional aircraft wings; namely, flow separation from the surface over the aft upper airfoil contour at high angles of attack. This is the major cause of “stalls” in airplanes.

As compared to the angle of attack of a conventional aircraft wing, “stalling” in the Levitator design delayed by its inlet duct configuration and the fact that airflow over the interior surfaces is compelled to follow the passage curvature, having no other available flow path. Thus, the lift forces generated by angular downward acceleration of the airstream are less dependent upon attack angle.

Given optimally-curved inlet edges (to minimize “inlet stall”) the Levitator's induced lift is affected only by the rpm of its impeller, plus variations in atmospheric density.

The Levitator also produces both lift and directional thrust by impeller-induced acceleration of its internal airstream. Since both of these are “vector” resultants of the axial acceleration produced by the whirling impeller, their magnitude and direction are functions not only of the impeller speed, but also of the angular orientation of the Levitator unit as a whole (both in its “static mounted position” and its relative variations from that caused by flight maneuvering)—plus the orientation of its controllable, variable-angle airflow outlet.

As an example of how these effects can interact in flight, consider a Levitator-powered PAC flying forward, approaching its desired landing spot. Its forward velocity can be arrested for a vertical landing in two ways—used separately or together.

(1) The Levitator outlet ducts can be diverted from their normal down-and-rearward alignment to a down-and-FORWARD-angled position. Thus their “directional-motion vector force” tends to retard, and eventually stop, forward progress of the PAC.

(2) The entire PAC can be tilted “nose-up”. This slows the aircraft in two simultaneous ways independent of, and in addition to, lift and drag effects on the PAC's wing surfaces:

A. The induced lift vectors of the Levitator unit inlets tilt rearwards, causing a motion-retarding effect; and

B. The dynamic lift vectors of the Levitator unit impeller axes tilt to a more forward orientation, thus adding to the retarding effect caused by deflection of the flow outlet ducts.

To summarize: the Levitator is a dual-acting lift-producing unit. It generates appreciably more Lift with the same (or less) power than a conventional ducted fan because of the “mechanical advantage” of generating lift from the deflection of its inlet airflow, in addition to the direct mass-acceleration reaction force exerted through the impeller action.

To clarify this advantage by analogy: the famous Piper J-3 Cub is a 2-seater airplane weighing 1220 pounds fully loaded. Its usual power is rated at 65 bhp, turning a 6-foot diameter propeller at 2300 rpm. There is no way that this engine/propeller system can lift the aircraft vertically, by direct thrust alone. However, when the engine's thrust is used to move the Cub's wing surfaces forward through the air, the resulting induced lift is ample to lift the 1220-pound aircraft upwards at 450 feet per minute.

The lift-producing capacity of the Levitator is accordingly greater than that of a conventional Ducted Fan unit in essentially the same way that a given amount of force can move a much heavier weight upward by pushing it along a slanting ramp, than it can by direct lifting action.

Levitator Control Considerations: The outlet duct of the Levitator is subject to neither high internal pressure nor excessive temperature. Therefore a plastic bellows-type flexible section (wire-reinforced for extra safety) can be used as a means of adjusting and/or controlling the direction of the Levitator outflow. The resultant forces from outflow deflection provide a convenient means of controlling the flight path, velocity, and attitude of an aircraft powered by these units.

The validity of this method of aircraft flight control—particularly at low or zero flight speeds—has been proven by such experimental aircraft as the British Hawker P.1127 (1961), which was the forerunner of today's “Harrier” jet fighters. The major problems encountered with gimbal-mounted jet engine orifices in jet aircraft of this type had to do with the very high temperatures and efflux velocities involved. The Levitator suffers from neither of these adverse conditions.

In the nominal design configuration proposed for prototype testing, the Levitator units are installed with their impeller centerlines tilted (e.g., approximately 26 degrees) from the vertical, with outlets to the rear. (This proposed orientation does not take into account the dynamic lift forces generated within the inlet ducts, and is subject to change as a result of routine experimentation.)

Because of the desirability of being able to bring the PAC vehicle to a quick stop in midair, the Levitator outlet ducts will most likely need to be deflected through a greater forward angle from their nominal “in-flight” positions than they will be deflected rearwards in cruising flight. Therefore it may well be advantageous to install the flexible “bellows” sections in a “pre-loaded” condition (partly deflected aft in “normal position”) to allow for this differential.

In the preferred configuration for the PAC, as shown in FIGS. 14 and 15, multiple Levitator units are provided on each side of the craft. For a number of reasons it appears best to group these units together, close to the PAC's design center of gravity (CG):

1. Failure in flight of any individual Levitator unit will produce minimal upsetting effect—and will require minimal compensation for that—if they are all grouped closely around the aircraft's design CG.

2. Control linkage problems will be minimized by this “grouped” arrangement of Levitators. In this regard it is desirable that the Levitator outlet ducts be connected in tandem pairs, such that they move together as control is applied by the pilot (or automatic pilot). In this way, if one Levitator unit fails, compensation for that failure can normally be accomplished by increasing the power output of its mated unit.

3. Closely grouping the Levitator units will decrease inertial effects, primarily those influencing lateral control. This may become an important safety consideration during hovering flight close to the ground (as in takeoffs and landings) where gusts and turbulence are probable and pose the greatest danger.

4. Power plant installation will be both simplified and lightened by this grouped arrangement.

PAC Airframe—Aerodynamic Considerations: The design elements of the PAC interact to a higher degree than in conventional aircraft design because of the several close inter-relationships of the power units, passenger-access provisions, stability requirements, aerodynamic efficiency, necessary light weight, durability, and safety. For example, a delta wing design would probably offer improved aerodynamic lift capability, a higher stalling angle, and a better strength-to-weight ratio than the configuration shown in FIGS. 14 and 15. However, using a delta wing makes passenger entry and exit much less convenient than the “car door” arrangement which a rectangular wing planform permits.

In view of the aforementioned inter-relationships, the configuration shown in FIGS. 14 and 15 offers acceptable compromises.

1. The rectangular, low-aspect-ratio wing has appreciable thickness—estimated at 20% to 25% of the chord. This has several structural benefits. Aerodynamically it permits a large leading edge radius, which in turn allows a wide range of attack angles in flight. This is intended to provide an essential element in low-speed maneuverability, permitting rapid changes in nose-up/nose-down attitude for collision avoidance and landing/taking off from limited-access areas.

2. The major aerodynamic drawbacks of a low-aspect ratio wing—tip losses and high drag—are minimized by the tip fins in the proposed design. These also serve as fairings for the wheels and can enhance directional stability (i.e. reduce “snaking” in flight). Controllable rudders inset into the fin trailing edges provide a positive means of directional changes in forward flight modes.

3. The use of a reflexed airfoil should enhance longitudinal stability in what amounts to a “flying plank” design. This has proven successful in an unpowered, single-seater, aerobatic glider of comparable planform to this PAC configuration of FIGS. 14 and 15. On the other hand, because of the presently unknown aerodynamic effects of the grouped Levitator ducts and their fairings, it may be sufficient to merely install the elevons at a negative angle of incidence, and use a more conventional non-reflexed airfoil. Routine experimentation with models can easily resolve this issue.

A vital consideration in this regard is that a reflexed airfoil has a low—possibly zero—center of pressure travel. This makes for a wider range of permissible flight CG positions, and minimizes necessary “trim” changes as the flight regime changes between hovering and forward flight. Advantageously, the addition of the top inlet ducts are optimized to insure the center of pressure position versus angle of attack.

PAC Airframe—Practical Considerations: Convenient passenger access and exit, excellent forward and side visibility (including a transparent area in the floor to assist in landings)—plus the possibility of being able to move the passenger seats fore and aft as may be required to insure a safe, in-flight CG location—all call for an automotive type of passenger accommodation.

The absolute necessity of correct in-flight CG location for the PAC mandates fail-safe methodology to prevent the PAC from ever being flown with an improper CG. The proposed “best method” of accomplishing this is with dual strain gauges at each wheel mount. The readouts from these gauges are fed to a computerized module which determines the actual PAC CG by comparing the strain gauge readings. If this CG determination is outside the permissible range, the engines cannot be started. Also, if any strain gauge gives a different reading from its twin, indicating possible failure and a potentially erroneous reading, the onboard computer module again prevents engine startup.

A “fly-by-wire” control system may be used in the PAC of this preferred design. Using well-proven piezoelectric gyrosscopes and digital proportional control of servomotors, much mechanical complexity can be avoided in the PAC'S control system. The “gyros”, operating as they do in an oscillatory mode, are free from the precession problems that affect rotating gyroscopes, and will permit the PAC's pilot to concentrate his/her attention on vital flight tasks such as accurate, gentle landing, without having to simultaneously compensate for turbulence (ambient or self-induced by close-to-the-ground outflow from the Levitators).

A further advantage of employing a “fly-by-wire” control system in conjunction with piezoelectric gyro sensors and a computerized central module is that this system can be programmed so as to prevent the PAC from being deliberately maneuvered into hazardous attitudes. Such a system would prevent all “aerobatic” maneuvering, and also restrict the attainable “angles of attack” of the vehicle to a safe range, where aerodynamic stalling cannot occur.

Flight controls must include provisions for directional, longitudinal (“pitch”), velocity, and altitude variations. They may include a means of lateral (“banking”) control, but this does not seem vital: close to the ground a level attitude is called for; and in-flight banking can be made automatic by the interactions of aerodynamic forces as the PAC's direction of flight is changed.

A “quadrant” type of pilot's control could be set up as follows: Turning the quadrant from side to side causes a change in direction. Pulling it back causes a reduction in forward speed or a complete stop in mid-air, while pushing the quadrant forward makes the PAC accelerate. Power changes may be made by twist-grips (as on motorcycle handlebars) on the quadrant ends. The various Levitator unit power and exit duct position adjustments can be computer-controlled in accordance with the control inputs provided by the pilot's control commands combined with the piezoelectric gyro outputs.

PAC Airframe—Structural Considerations: Because of the many compound curves required by the proposed PAC configuration, probably the most practical constructional technique would be “composite construction”, using the general “lost foam” technique employed by Burt Rutan in his various aircraft designs (e.g. the “Quickie”). An internal frame of welded metal tubing could be also used to provide a rigid central mounting for the pilot/passenger compartment, fuel tanks, cargo compartment, and Levitator units. In production, these various elements may be of molded design.

The structural design of the PAC should provide “crushability” as a protective feature to minimize injury to PAC passengers in impacts. Also, the wheels need not be retractable. At cruising speeds of 50 mph and less, the drag from these wheels will not be high, and their protrusion from the bottom can provide extra impact absorption.

Folding wings for this airframe configuration is probably impractical.

Access hatches must be provided for maintenance and inspection purposes. Federal Aircraft Regulations—FARs—will probably mandate such hatches. This may seem to be a minor consideration, but it is possible that hatches required for adequate access to the engines may affect the structural integrity of the contemplated “monocoque” design, and thus require additional internal stress-bearing components.

PAC Airframe—Further Considerations: Inasmuch as the proposed PAC is a man-carrying flying machine, its operation in flight will undoubtedly come under FAR restrictions. Two-way radio; some form of electronic navigation system; and basic aircraft flight instrumentation will be needed as a minimum. Operation of the PAC may be restricted, initially, to Visual Flight Rules (VFR), which will prohibit flight after dark or in marginal weather conditions.

Also, licensing of both the vehicle and its operator(s) will probably be required by law. FAR's have taken much of the former freedom away from experimental aircraft. On the other hand, Burt Rutan has shown that new and unorthodox aircraft can be developed and flown on a daily basis by “average pilots”. It is a primary object of the present invention to provide a VTOL aircraft or PAC which is extremely easy and, above all, safe to fly.

There has thus been shown and described a novel personal aircraft (PAC), and a Levitator therefor, which fulfill all the objects and advantages sought by the invention. Many changes, modifications, variations and other uses and applications of the subject invention will, however, become apparent to those skilled in the art after considering this specification and the accompanying drawings which disclose the preferred embodiment thereof. All such changes, modifications, variations and other uses and applications which do not depart from the spirit and scope of the invention are deemed to be covered by the invention, which is to be limited only by the claims which follow.

What is claimed is:

1. A personal aircraft (PAC) capable of vertical take-off and landing (VTOL) and comprising, in combination:
(a) a passenger compartment having a four sides, including a front side, a rear side and two lateral sides;
(b) a plurality of independently powered thrusters attached to said compartment, with at least two thrusters disposed on each of two opposite sides of said compartment, said thrusters being capable of providing vertical lift to said compartment;
wherein there is a total of at least four thrusters for redundancy in operation.

2. The PAC defined in claim 1, wherein said two or more thrusters on each opposite side are arranged adjacent each other in a cluster.

3. The PAC defined in claim 2, wherein four thrusters are arranged in said cluster on each opposite side.

4. The PAC defined in claim 1, wherein said two or more thrusters on each side are arranged along a straight line.

5. The PAC defined in claim 1, wherein said two or more thrusters on each side are arranged along a curved line.

6. The PAC defined in claim 1, wherein the thrust of each of said thrusters is independently controllable from said compartment.

7. The PAC defined in claim 1, wherein the outlet of at least one of said two or more thrusters on each side may be controlled to adjust the direction of thrust.

8. The PAC defined in claim 7, wherein the outlet of said at least one thruster is a tube for directing the flow of air, and wherein said direction of thrust is controlled by moving said tube.

9. The PAC defined in claim 1, further comprising an additional independently powered thruster attached to said compartment at one of said front side and said rear side thereof for directing thrust in at least one of a forward and rearward direction of the craft.

10. The PAC defined in claim 1, further comprising at least one wing on each side of said compartment to provide lift during forward movement of the craft.

11. The PAC defined in claim 10, wherein said wing on each side of the compartment is foldable toward and away from said compartment.

12. The PAC defined in claim 10, wherein said wing on each side of the compartment is collapsible and extendable, respectively, toward and away from said compartment.

13. The PAC defined in claim 1, wherein at least one of the thrusters on each opposite side of the compartment includes a duct having an inlet and an outlet and means for driving air through said duct from said inlet to said outlet.

14. The PAC defined in claim 13, wherein said air driving means includes an impeller, disposed for rotation within said duct, and a prime mover for rotating said impeller.

15. The PAC defined in claim 1, wherein at least one of the thrusters on each opposite side of the compartment comprises ducted fan apparatus including:
(1) a cylindrical first tube having an inlet, an outlet and a linear, first central axis which is disposed at an angle to the vertical when said craft is oriented in its normal upright position such that the inlet is located forward of the outlet, in relation to the direction of travel of said aircraft;
(2) a first impeller disposed in said first tube and arranged to rotate about said first central axis to generate airflow from the inlet to the outlet;
(3) a first prime mover coupled to drive said first impeller; and
(4) a second tube having an inlet and an outlet, the outlet of said second tube having substantially the same internal cross-sectional diameter area as that of said first tube, the outlet of said second tube extending into the inlet of said first tube, the inlet of said second tube facing forward in relation to said direction of travel and having a substantially horizontal, second central axis.

16. The PAC defined in claim 15, wherein said first prime mover is disposed in said first tube adjacent to said first impeller.

17. The PAC defined in claim 16, wherein said first prime mover is mounted on a plurality of stator blades which constrain air to flow through said first tube in the direction of said first central axis.

18. The PAC defined in claim 16, wherein said first prime mover is an internal combustion engine.

19. The PAC defined in claim 18, wherein the internal combustion engine has an intake port for the intake of air, said intake port being disposed outside of said first tube.

20. The PAC defined in claim 15, wherein said ducted fan apparatus further comprises a third tube having an inlet and an outlet, the inlet of said third tube being substantially cylindrical and having substantially the same internal diameter as that of said first tube, the outlet of said first tube extending into the inlet of said third tube.

21. The PAC defined in claim 20, wherein the outlet of said third tube has a circular cross section.

22. The PAC defined in claim 20, wherein the outlet of said third tube has a third central axis, and wherein said apparatus further includes means for adjusting the orientation of said third central axis with respect to that of said first central axis, thereby adjusting the direction of outflow of air.

23. The PAC defined in claim 22, wherein said third tube has at least one of a flexible and an articulated portion arranged between the inlet and outlet thereof to allow for the adjustment of orientation of said third central axis.

24. The PAC defined in claim 15, further comprising a second impeller disposed in said first tube and arranged to rotate about said first central axis in a direction opposite to the direction of rotation of said first impeller, said second impeller serving to redirect the air to flow in the axial direction within said first tube and to increase the speed of air at the outlet of said first tube.

25. The PAC defined in claim 24, wherein said first prime mover drives both said first and said second impeller.

26. The PAC defined in claim 24, further comprising a second prime mover coupled to drive said second impeller.

27. The PAC defined in claim 26, wherein said second prime mover is disposed in said first tube adjacent to said second impeller.

28. The PAC defined in claim 27, wherein said second prime mover is coupled to said first prime mover to rotate in synchronism in opposite direction.

29. The PAC defined in claim 27, wherein said second prime mover is a second internal combustion engine.

30. The PAC defined in claim 29, wherein the second internal combustion engine has an intake port for the intake of air, said intake port being disposed outside of said first tube.

31. The PAC defined in claim 15, wherein the inlet of said second tube has a circular opening.

32. The PAC defined in claim 15, wherein the inlet of said second tube has a substantially rectangular opening, said opening having upper and lower substantially horizontal edges and two side edges.

33. The PAC defined in claim 32, wherein the upper edge of the opening in the inlet of said second tube has an aerodynamic contour which produces lift due to airflow into such inlet.

34. The PAC defined in claim 32, wherein the lower edge of the opening in the inlet of said second tube has an aerodynamic contour which produces lift due to airflow into such inlet.

35. The PAC defined in claim 15, wherein the inlet of said second tube has at least one edge surrounding an inlet opening, said edge defining a substantially planar face of the inlet which forms an acute angle with respect to said second central axis.

36. The PAC defined in claim 35, wherein said acute angle is in the range of 35 to 55 degrees.

37. The PAC defined in claim 36, wherein said acute angle is substantially 45 degrees.

38. The PAC defined in claim 15, further comprising second ducted fan apparatus, substantially identical to said apparatus defined in claim 15, disposed adjacent to said apparatus defined in claim 15, with the inlets of the second tubes thereof disposed one above the other.

39. The PAC defined in claim 15, further comprising second ducted fan apparatus, substantially identical to said apparatus defined in claim 15, disposed adjacent to said apparatus defined in claim 15, with the inlets of the second tubes thereof disposed laterally adjacent each other.

40. The PAC defined in claim 15, wherein said first axis is disposed at an angle to the vertical in the range of 15 to 35 degrees.

41. Ducted fan apparatus arranged on a vertical take-off and landing (VTOL) aircraft, said apparatus comprising, in combination:
(a) a cylindrical first tube having an inlet, an outlet and a linear, first central axis which is disposed at an angle to the vertical when said aircraft is oriented in its normal upright position such that the inlet is located forward of the outlet, in relation to the direction of travel of said aircraft;
(b) a first impeller disposed in said first tube and arranged to rotate about said first central axis to generate airflow from the inlet to the outlet;
(c) a first prime mover coupled to drive said first impeller; and
(d) a second tube having an inlet and an outlet, the outlet of said second tube having the same internal cross-sectional area as that of said first tube, the outlet of said second tube extending coaxially with, and smoothly into, the inlet of said first tube, the inlet of said second tube facing forward in relation to said direction of travel and having a substantially horizontal, second central axis.

42. The ducted fan apparatus defined in claim 41, wherein said first prime mover is disposed in said first tube adjacent to said first impeller.

43. The ducted fan apparatus defined in claim 42, wherein said first prime mover is an internal combustion engine.

44. The ducted fan apparatus defined in claim 42, wherein said first prime mover is mounted on a plurality of stator blades which constrain air to flow through said first tube in the direction of said first central axis.

45. The ducted fan apparatus defined in claim 41, further comprising a third tube having an inlet and an outlet, the inlet of said third tube being cylindrical and having the same internal diameter as that of said first tube, the outlet of said first tube extending coaxially with, and smoothly into, the inlet of said third tube.

46. The ducted fan apparatus defined in claim 45, wherein the outlet of said third tube has a circular cross section.

47. The ducted fan apparatus defined in claim 45, wherein the outlet of said third tube has a third central axis, and wherein said apparatus further includes means for adjusting the orientation of said third central axis with respect to that of said first central axis, thereby adjusting the direction of outflow of air.

48. The ducted fan apparatus defined in claim 47, wherein said third tube has at least one of a flexible and an articulated portion arranged between the inlet and outlet thereof to allow for the adjustment of orientation of said third central axis.

49. The ducted fan apparatus defined in claim 41, further comprising a second impeller disposed in said first tube and arranged to rotate about said first central axis in a direction opposite to the direction of rotation of said first impeller, said second impeller serving to increase the outflow of air at the outlet of said first tube.

50 The ducted fan apparatus defined in claim 49, wherein said first prime mover drives both said first and said second impeller.

51. The ducted fan apparatus defined in claim 49, further comprising a second prime mover coupled to drive said second impeller.

52. The ducted fan apparatus defined in claim 51, wherein said second prime mover is disposed in said first tube adjacent to said second impeller.

53. The ducted fan apparatus defined in claim 41, wherein the inlet of said second tube has a circular cross section.

54. The ducted fan apparatus defined in claim 41, wherein the inlet of said second tube has a substantially rectangular opening, said opening having upper and lower substantially horizontal edges and two side edges.

55. The ducted fan apparatus defined in claim 54, wherein the upper edge of the opening in the inlet of said second tube has an aerodynamic contour which produces lift due to airflow into such inlet.

56. The ducted fan apparatus defined in claim 54, wherein the lower edge of the opening in the inlet of said second tube has an aerodynamic contour which produces lift due to airflow into such inlet.

57. The ducted fan apparatus defined in claim 41, wherein the inlet of said second tube has at least one edge surrounding an inlet opening, said edge defining a substantially planar face of the inlet which forms an acute angle with respect to said second central axis.

58. The ducted fan apparatus defined in claim 57, wherein said acute angle in the range of 35 to 55 degrees.

59. The ducted fan apparatus defined in claim 58, wherein said acute angle is substantially 45 degrees.

60. The ducted fan apparatus defined in claim 43, wherein the internal combustion engine has an intake port for the intake of air, said intake port being disposed outside of said first tube.

61. The ducted fan apparatus defined in claim 41, further comprising second ducted fan apparatus, substantially identical to said apparatus defined in claim 41, disposed adjacent to said apparatus defined in claim 41, with the inlets of the second tubes thereof disposed one above the other.

62. The ducted fan apparatus defined in claim 41, further comprising second ducted fan apparatus, substantially identical to said apparatus defined in claim 41, disposed adjacent to said apparatus defined in claim 41, with the inlets of the second tubes thereof disposed laterally adjacent each other.

63. The ducted fan apparatus defined in claim 41, wherein said first axis is disposed at an angle to the vertical in the range of 15 to 35 degrees.

64. The ducted fan apparatus defined in claim 63, wherein said first axis is disposed at an angle to the vertical of substantially 26 degrees.

65. The PAC defined in claim 1, wherein said passenger compartment is configured as a lifting body, to provide lift to the craft during forward motion through the air.

66. The PAC defined in claim 1, wherein said passenger compartment has a top and a center of gravity, said PAC further comprising a parachute arranged at the top, in substantially vertical alignment with the center of gravity, for deployment in the event of thruster failure.

67. The PAC defined in claim 1, wherein said passenger compartment has a bottom and a center of gravity, said PAC further comprising an airbag arranged at on the bottom, in substantially vertical alignment with the center of gravity, for deployment in the event of thruster failure.
